(19) United States
(12) Patent Application Publication
(10) Pub. No.: US 2012/0161471 A1
(43) Pub. Date: Jun. 28, 2012

(54) TRAILER ROOF INSTALLATION ASSEMBLY

(75) Inventors: Matt K. Arnold, Bristol, IN (US); William R. Irelan, Elkhart, IN (US); Michael P. Brady, Edwardsburg, MI (US)

(73) Assignee: LGS INDUSTRIES, INC., Bristol, IN (US)

(21) Appl. No.: 13/334,796

(22) Filed: Dec. 22, 2011

Related U.S. Application Data
(60) Provisional application No. 61/426,793, filed on Dec. 23, 2010.

(51) Int. Cl. B62D 25/06; B23P 11/00

(52) U.S. Cl. 296/185.1; 296/104; 29/897.2

(57) ABSTRACT

A trailer roof assembly includes a horizontal roof member and a vertical wall member. An arcuate member is connected on a first end with the vertical wall member and on a second end with the horizontal roof member. The arcuate roof member includes a nub that extends outwardly and abuts the horizontal roof member. A fastener extends through the horizontal roof member and the arcuate member into a channel disposed on an underside of the arcuate member. A trim piece is disposed in the channel hiding the fastener from view.

### CROSS-REFERENCE TO RELATED APPLICATION

This application claims the benefit of and priority to U.S. Provisional Patent Application No. 61/426,793, filed on Dec. 23, 2010, entitled “TRAILER ROOF INSTALLATION ASSEMBLY,” the entire disclosure of which is hereby incorporated herein by reference.

### BACKGROUND OF THE INVENTION

The present invention generally relates to a method for installing a roof assembly in a cargo trailer.

### SUMMARY OF THE INVENTION

According to one aspect of the present invention, a trailer roof assembly includes a horizontal roof member and a vertical wall member. An arcuate member is connected on a first end with the vertical wall member and on a second end with the horizontal roof member. The arcuate roof member includes a nub that extends outwardly and abuts the horizontal roof member. A fastener extends through the horizontal roof member and the arcuate member into a channel disposed on an underside of the arcuate member. A trim piece is disposed in the channel hiding the fastener from view.

According to another aspect of the present invention, a trailer roof transition piece includes an arcuate member defining a concave side and a convex side and having a first end adapted for connection with a vertical wall member and a second end adapted for connection with a horizontal roof member. A nub extends outwardly from the convex side of the arcuate member. A channel is disposed on the concave side of the arcuate member. A trim piece is disposed in the channel.

According to yet another aspect of the present invention, a method of installing a trailer roof includes positioning an arcuate member having a convex side and a concave side between a horizontal roof member and a vertical wall member. A channel is formed on the concave side of the arcuate member. The arcuate member is coupled to the vertical member with a fastener. An elongate polymeric trim piece is positioned on the concave side over a portion of the fastener.

Trailers are generally constructed utilizing a variety of components that are held together by various mechanical fasteners including screws and nails. During the construction of roofing assemblies, components are assembled and then connected by mechanical fasteners. Mechanical fasteners are oftentimes set through the top of the roofing surface downward into the trailer. As a result, the screw tip or nail tip is exposed inside the trailer, providing an unsightly and aesthetically displeasing condition to a user.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side perspective view of one embodiment of a trailer using one embodiment of a trailer roof transition piece of the present invention;

FIG. 2 is a bottom perspective view of a trailer roof transition piece of the present invention prior to assembly;

FIG. 2A is a partial side cross-sectional view of the trailer roof transition piece of FIG. 2;

FIG. 3 is a bottom perspective view of a trailer roof transition piece of the present invention during installation of a trim piece;

FIG. 3A is a partial side cross-sectional view of the trailer roof transition piece of FIG. 3;

FIG. 4 is a bottom perspective view of a trailer roof transition piece of the present invention after assembly; and

FIG. 4A is a partial side cross-sectional view of the trailer roof transition piece of FIG. 4.

### DETAILED DESCRIPTION OF EMBODIMENTS

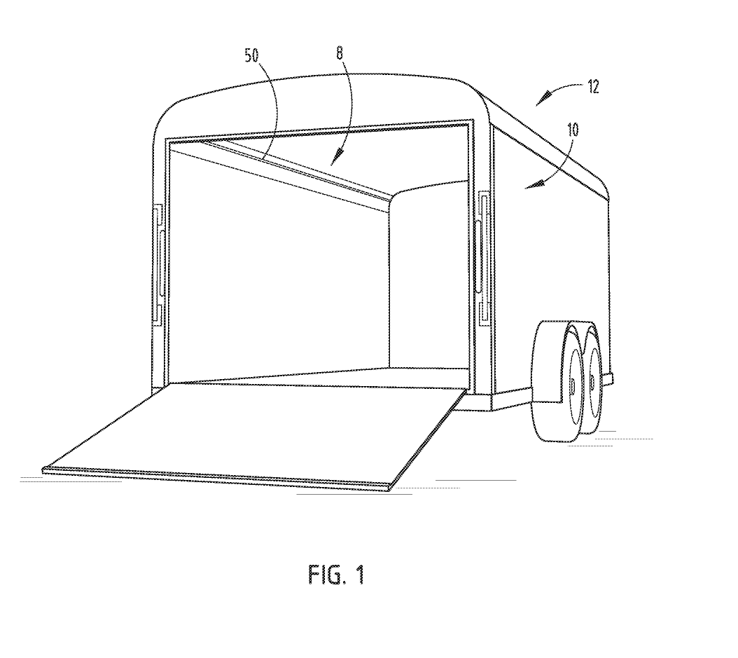

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

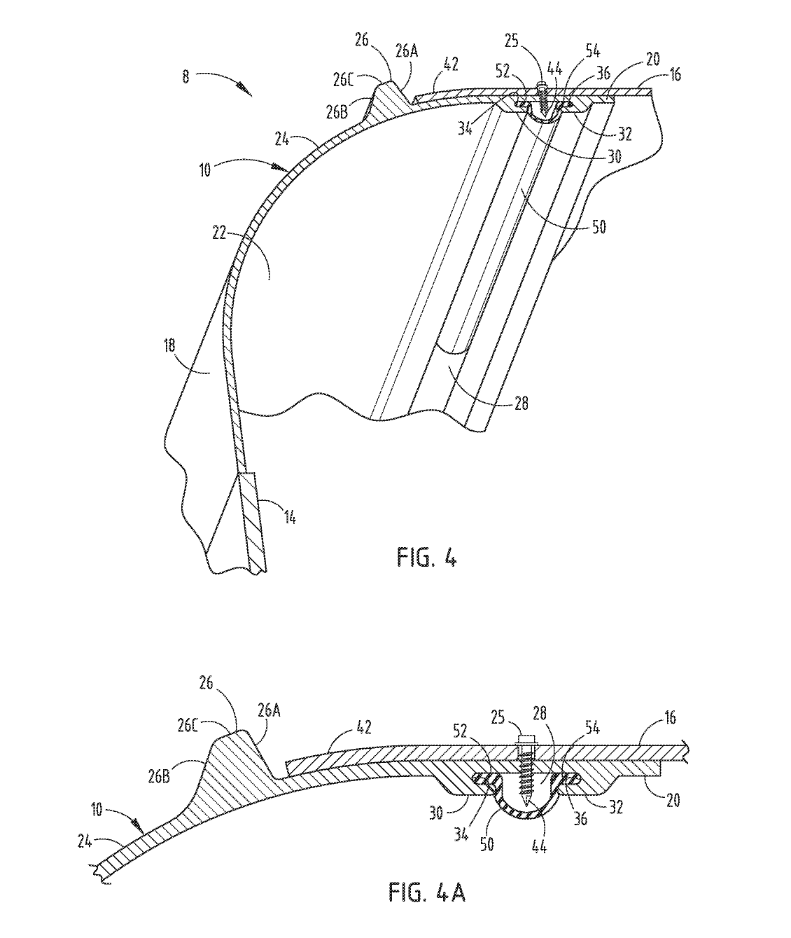

Referring to FIGS. 1-5, a trailer roof installation assembly 8 includes an arch member 10 is provided inside a trailer 12 that is designed to connect vertically-extending sidewalls 14 of the trailer 12 to a lateral horizontally-extending roof member 16. The arch member 10 includes a base 18 and a top portion 20 with an inside face 22 and an outside face 24. The arch member 10 also includes an abutment member 26 on the outside face 24 thereof. The abutment member 26 includes a substantially planar abutment side 26A, a substantially arcuate back side 26B, and a top side 26C. The arch member 10 is rigidly connected with the sidewalls 14 during construction via mechanical fasteners 25. The inside face 22 of the top portion 20 of the arch member 10 includes a channel 28 adapted to receive mechanical fasteners 25. The channel 28 is defined by first and second curved walls 30, 32. The first and second curved walls 30, 32, as illustrated, curve inwardly toward one another, thereby forming first and second receiving slots 34, 36, which are discussed in further detail below. It is contemplated that the first and second curved walls 30, 32 may include a variety of other constructions including angular and linear configurations.

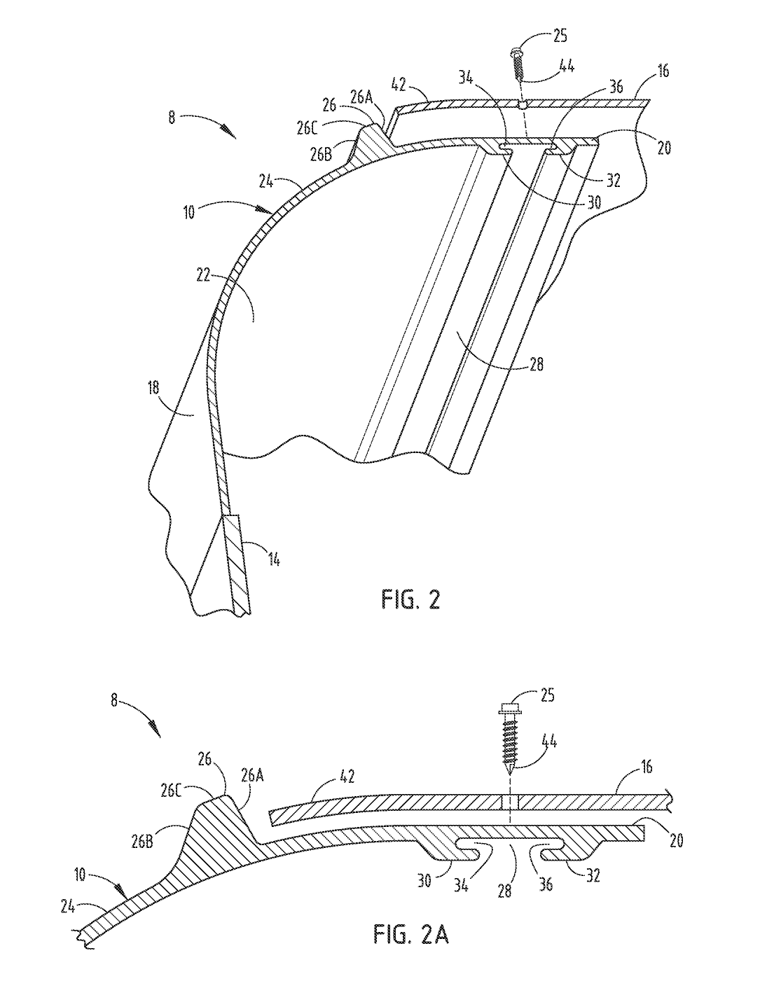

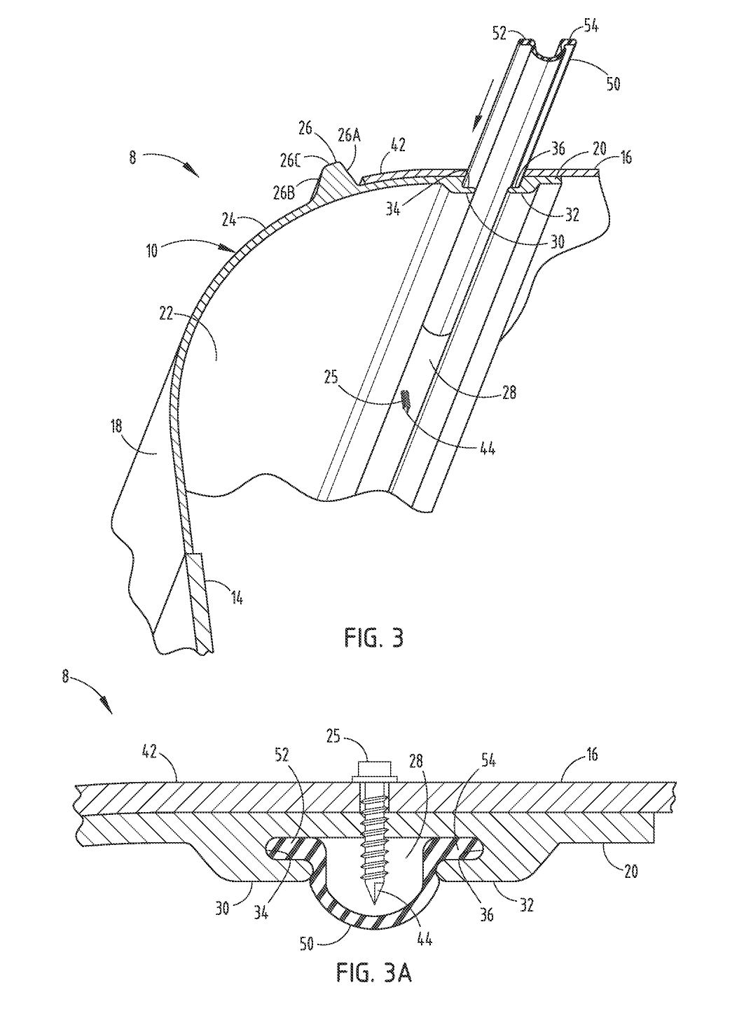

During the manufacturing process, an end of the horizontally-extending roof member 16 is positioned over the arch member 10 in abutting contact with the abutment member 26. The mechanical fasteners 25 are then driven through a top side 42 (FIG. 2) of the horizontally-extending roof member 16 and through the outside face 24 of the arch member 10 proximate the channel 28. Tips 44 (FIGS. 2 and 2A) of the mechanical fasteners 25 extend downward into the channel 28. After the mechanical fasteners 25 are driven through both the horizontally-extending roof member 16 and the arch member 10, into the channel 28, the tips 44 of the mechanical fasteners 25 are left exposed. A plastic trim piece 50 (FIG. 3) is slid along the channel 28 on the inside face 22 of the arch member 10. The plastic trim piece 50 includes first and second engagement legs 52, 54 adapted to extend into the first and second receiving slots 34, 36, respectively, formed by the first and second curved walls 30, 32 of the arch member 10. Accordingly, when the mechanical fasteners 25 extend through the horizontally-extending roof member 16 downward into the channel 28 of the arch member 10, the tips 44 of the mechanical fasteners 25 are not exposed inside the trailer 12. Rather, the tips 44 of the mechanical fasteners 25 are positioned inside the flexible plastic trim piece 50 that extends along the channel 28. Not only is the number of mechanical fasteners 25 generally hidden from view by the user, the number of mechanical fasteners 25 and placement of those mechanical fasteners 25 are hidden. Alternatively, the plastic trim piece 50 may be positioned in the channel 28 prior to installation of the mechanical fasteners 25 to hide the tips 44 of the mechanical fasteners 25 from view.

After the mechanical fasteners 25 have been secured, a caulk or adhesive mixture is applied to a top surface of the completed roof to waterproof the roof assembly. Additional exterior or interior trim pieces 50 that are pleasing to the eye of a consumer may also be added to the finished trailer 12 construction.

The trailer roof installation assembly 8, as disclosed in detail above, provides an easily installed and aesthetically pleasing construction. The positive connection of the arch member 10 and the horizontally-extending roof member 16 by mechanical fasteners 25 provides a solid roof structure for a variety of trailers 12. In addition, the flexible trim piece 50 hides from view the exposed mechanical fastener tips 44 that would otherwise extend into the trailer 12 or engage a thin wood shim secured to a top portion of the trailer 12, which can be very costly and unsightly.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the preferred and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A trailer roof assembly comprising:
a horizontal roof member;
a vertical wall member;
an arcuate member connected on a first end with the vertical wall member and on a second end with the horizontal roof member, wherein the arcuate roof member includes a nub that extends outwardly and abuts the horizontal roof member;
a fastener that extends through the horizontal roof member and the arcuate member into a channel disposed on an underside of the arcuate member; and
a trim piece disposed in the channel hiding the fastener from view.

2. The trailer roof assembly of claim 1, further comprising:
first and second walls that define the channel.

3. The trailer roof assembly of claim 1, wherein the first and second walls curve inwardly toward one another and define first and second receiving slots.

4. The trailer roof assembly of claim 1, wherein the trim piece includes first and second engagement legs.

5. The trailer roof assembly of claim 1, wherein the horizontal roof member and vertical wall member are constructed of aluminum.

6. The trailer roof assembly of claim 1, wherein the nub includes a substantially planar abutment side and a substantially arcuate back side.

7. A trailer roof transition piece comprising:
an arcuate member defining a concave side and a convex side and having a first end adapted for connection with a vertical wall member and a second end adapted for connection with a horizontal roof member;
a nub that extends outwardly from the convex side of the arcuate member;
a channel disposed on the concave side of the arcuate member; and
a trim piece disposed in the channel.

8. The trailer roof transition piece of claim 7, further comprising:
first and second walls that define the channel.

9. The trailer roof transition piece of claim 7, wherein the first and second walls curve inwardly toward one another and define first and second receiving slots.

10. The trailer roof transition piece of claim 7, wherein the trim piece includes first and second engagement legs.

11. The trailer roof transition piece of claim 7, wherein the arcuate member is constructed from aluminum.

12. The trailer roof transition piece of claim 7, wherein the trim piece is constructed of a polymeric material.

13. A method of installing a trailer roof comprising:
positioning an arcuate member having a convex side and a concave side between a horizontal roof member and a vertical wall member;
forming a channel on the concave side of the arcuate member;
coupling the arcuate member to the vertical member with a fastener; and
positioning an elongate polymeric trim piece on the concave side over a portion of the fastener.

14. The method of claim 13, further comprising:
forming first and second walls on the concave side that define the channel.

15. The method of claim 13, further comprising:
curving the walls inwardly toward one another to define first and second receiving slots.

16. The method of claim 13, further comprising:
providing first and second engagement legs on the trim piece.

17. The method of claim 13, further comprising:
forming the arcuate member from aluminum.

18. The method of claim 13, further comprising:
forming the trim piece from a polymeric material.
